(19) United States
(12) Patent Application Publication
(10) Pub. No.: US 2017/0077630 A1
(43) Pub. Date: Mar. 16, 2017

(54) M.2 INTERFACE CONNECTOR AND M.2 INTERFACE CONNECTION SEAT INSERTEDLY PROVIDED THEREOF

(71) Applicant: INNODISK CORPORATION, New Taipei City (TW)

(72) Inventors: CHEN-HUAN LIN, NEW TAIPEI CITY (TW); HSIAO-YU WANG, NEW TAIPEI CITY (TW)

(21) Appl. No.: 14/962,235

(22) Filed: Dec. 8, 2015

(30) Foreign Application Priority Data
Sep. 10, 2015 (TW) 104129986

(51) Int. Cl. H01R 12/72; H01R 13/627

(52) U.S. Cl. CPC H01R 12/721; H01R 13/6273

(57) ABSTRACT

The invention provides a connector and a connection seat insertedly provided thereof, particularly to a connector and a connection seat conforming to M.2 interface standard specification. The M.2 interface connector comprises a M.2 interface card and a housing. The housing is used for cladding the body of the M.2 interface card. The housing is provided on at least one side surface thereof with at least one fixed member. The M.2 interface card is having a connection interface protruding from the bottom end of the housing. The M.2 interface connection seat is disposed on a circuit board, and it's top end is provided with a slot. The opening direction of the slot will be perpendicular to the surface of the circuit board. When the connection interface of the M.2 interface connector is inserting into the slot of the M.2 interface connection seat based on a vertical direction, the fixed member of the housing will be fixed on the body of the M.2 interface connection seat. Therefore, the M.2 interface connector may be steady fixed in the slot of the M.2 interface connection seat by the fixed member.

### BACKGROUND

Technical Field

The present invention relates to a connector and a connection seat insertedly provided thereof, more particularly, to a connector and a connection seat conforming to M.2 interface standard specification.

Description of Related Art

M.2 is a new standard transmission interface specification produced by the standard specification organizations PCI-SIG and SATA-IO. M.2, originally known as the NGFF (Next Generation Form Factor), is now called M.2. M.2 supports the interfaces of SATA, USB and PCIe with various dimensions of standard specification, and has the advantage of fast transmission speed, and can be applied to various kinds of expansion cards like the solid state disk (SSD), WIFI, Bluetooth and near field communication (NFC), etc.

Referring to FIG. 1(A) and FIG. 1(B), there are shown the three-dimensional view of the M.2 interface card inserting into the M.2 interface connection seat in prior arts. As shown in the figures, the M.2 interface connection seat 15 is disposed on a circuit board 10. The M.2 interface connection seat 15 is provided with a slot for inserting the M.2 interface card 11, and the opening direction of the slot is parallel to the surface of the circuit board 10. So the M.2 interface card 11 is inserting into the slot of the M.2 interface connection seat 15 based on a horizontal direction. The rear end of the M.2 interface card 11 is provided with a notch 111, and the circuit board 10 is provided with a hole 101. When the M.2 interface card 11 is inserting into the M.2 interface connection seat 15, the notch 111 will be aligned with the hole 101 of the circuit board 10. A screw fixed member 17 can via the notch 111 and hole 101 to fix the M.2 interface card 11 on the circuit board 10.

When the M.2 interface card 11 is inserting into the slot of the M.2 interface connection seat 15 based on a horizontal direction in prior arts, the circuit board 10 needs to preserve certain area around the M.2 interface connection seat 15 for setting up the M.2 interface card 11, and it will reduce the area for setting up other interface members (like USB, SATA and PCIe). Moreover, the M.2 interface card 11 is developed with various specifications like 22 mm (width)×30 mm (length), 22 mm×42 mm, 22 mm×60 mm, 22 mm×80 mm and 22 mm×110 mm. If the reserved length of the circuit board 10 for the M.2 interface card 11 is limited, the longer M.2 interface card 11 will not be able to set up on the circuit board 10. For example, the reserved length of the circuit board 10 for the M.2 interface card 11 is 75 mm, then the M.2 interface card 11 in the specifications of 22 mm×30 mm, 22 mm×42 mm or 22 mm×60 mm are able to set up on the circuit board 10, and the length of the M.2 interface card 11 in the specifications of 22 mm×80 mm or 22 mm×110 mm are longer then the capable length of the circuit board 10 (like 80 mm/110 mm>75 mm) and not able to set up on the circuit board 10.

Moreover, the M.2 interface card 11 is usually fixed on the circuit board 10 by the screw fixed member 17 to stably insert into the slot of the M.2 interface connection seat 15. It requires a screwdriver to install the M.2 interface card 11 on the circuit board 10 or disassemble it from the circuit board 10, and there is a certain inconvenience of the operation.

### SUMMARY

It is one object of the present invention to provide a M.2 interface connector and a M.2 interface connection seat insertedly provided thereof, wherein the M.2 interface connection seat is disposed on a circuit board, and the opening direction of the slot of the M.2 interface connection seat is perpendicular to the surface of the circuit board. When the M.2 interface connector is inserting into the M.2 interface connection seat, the M.2 interface connector will be vertically disposed on the circuit board. The circuit board doesn't need to preserve certain area around the M.2 interface connection seat for setting up the M.2 interface connector in this way, and it will prevent affecting the setup of other interface components. Then the M.2 interface connector of every size and length can be set up on the circuit board vertically.

It is another object of the present invention to provide a M.2 interface connector and a M.2 interface connection seat insertedly provided thereof, wherein the M.2 interface connector provides with a housing, and it provides a set of fixed members on the housing of the M.2 interface connector and the body of the M.2 interface connection seat. The M.2 interface connector will be fixed on the M.2 interface connection seat by the set of fixed members.

It is another object of the present invention to provide a M.2 interface connector and a M.2 interface connection seat insertedly provided thereof, wherein the M.2 interface connector combines with the M.2 interface connection seat by the fixed members, which are easy to install and disassemble. It is easy to install the M.2 interface connector on the M.2 interface connection seat or disassemble it from the M.2 interface connection seat, and it will improve the convenience of the operation.

To achieve the aforementioned object, the present invention provides a M.2 interface connection seat, which is a interface connection seat conforming to M.2 interface standard specification, is disposed on a circuit board, and it's top end is provided with a slot, the opening direction of the slot is perpendicular to the surface of the circuit board, wherein the slot of the M.2 interface connection seat is provided for inserting a M.2 interface connector.

In one embodiment of this invention, wherein the M.2 interface connection seat is provided on at least one side surface thereof with at least one protruding part, and the M.2 interface connector is provided on at least one side surface thereof with at least one fastener, when the M.2 interface connector is inserting into the slot of the M.2 interface connection seat, the fastener will be fixed on the protruding part.

In one embodiment of this invention, wherein the M.2 interface connection seat is provided on at least one side surface thereof with at least one depression part, and the M.2 interface connector is provided on at least one side surface thereof with at least one fastener, when the M.2 interface connector is inserting into the slot of the M.2 interface connection seat, the fastener will be fixed on the depression part.

In one embodiment of this invention, wherein the slot of M.2 interface connection seat is formed by two short sides and two long sides, the two sides of the short side of the slot provide with a coupling slot respectively, the M.2 interface connector includes two long side surfaces and two short side surfaces, the two short side surfaces of the M.2 interface connector provide with at least one coupling member respectively, the coupling member includes a pressing portion, which extending downward provides with a hook, when the M.2 interface connector is inserting into the slot of the M.2 interface connection seat, the hook will be fixed in a coupling hole of the coupling slot, when pressing the pressing portion of the coupling member, the hook will be separated from the coupling hole of the coupling slot.

In one embodiment of this invention, wherein the slot of M.2 interface connection seat is formed by two short sides and two long sides, the long side of the slot provides with at least one coupling slot, the M.2 interface connector includes two long side surfaces and two short side surfaces, the long side surface of the M.2 interface connector provides with at least one coupling member, the coupling member includes a pressing portion, which extending downward provides with a hook, when the M.2 interface connector is inserting into the slot of the M.2 interface connection seat, the hook will be fixed in a coupling hole of the coupling slot, when pressing the pressing portion of the coupling member, the hook will be separated from the coupling hole of the coupling slot.

In one embodiment of this invention, wherein the coupling hole of the coupling slot is a hollow opening.

In one embodiment of this invention, wherein the bottom of the housing of the M.2 interface connector provides with a housing extension part, when the M.2 interface connector is inserting into the slot of the M.2 interface connection seat, the housing extension part will surround the outer surface of the body of the M.2 interface connection seat and tightly touch the outer surface of the body of the M.2 interface connection seat.

In one embodiment of this invention, there is a fixed gap between the M.2 interface connection seat and the circuit board, and at least one side surface of the M.2 interface connector provides with a fastener, when the M.2 interface connector is inserting into the slot of the M.2 interface connection seat, the fastener will be fixed in the fixed gap.

In one embodiment of this invention, wherein the slot of the M.2 interface connection seat is formed by two short sides and two long sides, the two sides of the short side of the slot provide with a position cooper tube respectively, the M.2 interface connector includes two long side surfaces and two short side surfaces, the two short side surfaces of the M.2 interface connector extending provide with a screw fixed member respectively, when the M.2 interface connector is inserting into the slot of the M.2 interface connection seat, using the screw bolt between the screw fixed member and the position cooper tube to fix the M.2 interface connector on the M.2 interface connection seat.

To achieve the aforementioned object, the present invention further provides a M.2 interface connector, comprising: a M.2 interface card, which is conforming to M.2 interface standard specification; and a housing, setting in the outside of the M.2 interface card to wrap the body of the M.2 interface card, the connection interface of the M.2 interface card is protruding from the bottom end of the housing, at least one side surface of the housing provides with at least one fixed member; when the connection interface of the M.2 interface card is inserting into a slot of the top end of a M.2 interface connection seat based on a vertical direction, the fixed member of the housing will be fixed on the body of the M.2 interface connection seat.

In one embodiment of this invention, wherein the fixed member of the side surface of the housing is a fastener, the M.2 interface connection seat is provided on at least one side surface thereof with at least one protruding part, when the connection interface of the M.2 interface card is inserting into the slot of the M.2 interface connection seat, the fastener will be fixed on the protruding part.

In one embodiment of this invention, wherein the fixed member of the side surface of the housing is a fastener, the M.2 interface connection seat is provided on at least one side surface thereof with at least one depression part, when the connection interface of the M.2 interface card is inserting into the slot of the M.2 interface connection seat, the fastener will be fixed on the depression part.

In one embodiment of this invention, wherein the sides of the housing include two long side surfaces and two short side surfaces, the two short side surfaces of the housing provide with the fixed member respectively, the fixed member is a coupling member, the coupling member includes a pressing portion, which extending downward provides with a hook, the slot of the M.2 interface connection seat is formed by two short sides and two long sides, the two sides of the short side of the slot provide with a coupling slot respectively, when the connection interface of the M.2 interface card is inserting into the slot of the M.2 interface connection seat, the hook will be fixed in a coupling hole of the coupling slot, when pressing the pressing portion of the coupling member, the hook will be separated from the coupling hole of the coupling slot.

In one embodiment of this invention, wherein the sides of the housing include two long side surfaces and two short side surfaces, the two long side surfaces of the housing provide with the fixed member respectively, the fixed member is a coupling member, the coupling member includes a pressing portion, which extending downward provides with a hook, the slot of M.2 interface connection seat is formed by two short sides and two long sides, the long side of the slot provides with at least one coupling slot, when the connection interface of the M.2 interface card is inserting into the slot of the M.2 interface connection seat, the hook will be fixed in a coupling hole of the coupling slot, when pressing the pressing portion of the coupling member, the hook will be separated from the coupling hole of the coupling slot.

In one embodiment of this invention, wherein the coupling hole of the coupling slot is a hollow opening.

In one embodiment of this invention, wherein the bottom of the housing of M.2 interface connector provides with the fixed member, the fixed member is a housing extension part, when the connection interface of the M.2 interface card is inserting into the slot of the M.2 interface connection seat, the housing extension part will surround the outer surface of the body of the M.2 interface connection seat and tightly touch the outer surface of the body of the M.2 interface connection seat.

In one embodiment of this invention, there is a fixed gap between the M.2 interface connection seat and the circuit board, and the fixed member of the side surface of the housing is a fastener, when the connection interface of the M.2 interface card is inserting into the slot of the M.2 interface connection seat, the fastener will be fixed in the fixed gap.

In one embodiment of this invention, wherein the sides of the housing include two long side surfaces and two short side surfaces, the two short side surfaces of the housing extending provides with the fixed member respectively, the fixed member is a screw fixed member, the slot of M.2 interface connection seat is formed by two short sides and two long sides, the two sides of the short side of the slot provide with a position cooper tube respectively, when the connection interface of the M.2 interface card is inserting into the slot of the M.2 interface connection seat, using the screw bolt between the screw fixed member and the position cooper tube to fix the M.2 interface connector on the M.2 interface connection seat.

### BRIEF DESCRIPTION OF THE DRAWING

An illustrative embodiment of the present invention will be further discussed with reference to the accompanying drawing, in which:

FIG. 1(A) is a three-dimensional view of the M.2 interface card inserting into the M.2 interface connection seat in prior arts;

FIG. 1(B) is another three-dimensional view of the M.2 interface card inserting into the M.2 interface connection seat in prior arts;

FIG. 2(A) and FIG. 2(B) are the three-dimensional view and the cross-sectional view of the M.2 interface connector and the M.2 interface connection seat separated in accordance with an embodiment of the present invention.

FIG. 2(C) and FIG. 2(D) are the three-dimensional view and the cross-sectional view of the M.2 interface connector inserting into the M.2 interface connection seat in accordance with an embodiment of the present invention.

FIG. 3(A) and FIG. 3(B) are the three-dimensional view and the cross-sectional view of the M.2 interface connector and the M.2 interface connection seat separated in accordance with another embodiment of the present invention.

FIG. 3(C) and FIG. 3(D) are the three-dimensional view and the cross-sectional view of the M.2 interface connector inserting into the M.2 interface connection seat in accordance with another embodiment of the present invention.

FIG. 4(A) and FIG. 4(B) are the three-dimensional view and the cross-sectional view of the M.2 interface connector and the M.2 interface connection seat separated in accordance with another embodiment of the present invention.

FIG. 4(C) and FIG. 4(D) are the three-dimensional view and the cross-sectional view of the M.2 interface connector inserting into the M.2 interface connection seat in accordance with another embodiment of the present invention.

FIG. 5(A) and FIG. 5(B) are the three-dimensional view and the cross-sectional view of the M.2 interface connector and the M.2 interface connection seat separated in accordance with another embodiment of the present invention.

FIG. 5(C) and FIG. 5(D) are the three-dimensional view and the cross-sectional view of the M.2 interface connector inserting into the M.2 interface connection seat in accordance with another embodiment of the present invention.

FIG. 6(A) and FIG. 6(B) are the three-dimensional view and the cross-sectional view of the M.2 interface connector and the M.2 interface connection seat separated in accordance with another embodiment of the present invention.

FIG. 6(C) and FIG. 6(D) are the three-dimensional view and the cross-sectional view of the M.2 interface connector inserting into the M.2 interface connection seat in accordance with another embodiment of the present invention.

FIG. 7(A) and FIG. 7(B) are the three-dimensional view and the cross-sectional view of the M.2 interface connector and the M.2 interface connection seat separated in accordance with another embodiment of the present invention.

FIG. 7(C) and FIG. 7(D) are the three-dimensional view and the cross-sectional view of the M.2 interface connector inserting into the M.2 interface connection seat in accordance with another embodiment of the present invention.

FIG. 8(A) and FIG. 8(B) are the three-dimensional view and the cross-sectional view of the M.2 interface connector and the M.2 interface connection seat separated in accordance with another embodiment of the present invention.

FIG. 8(C) and FIG. 8(D) are the three-dimensional view and the cross-sectional view of the M.2 interface connector inserting into the M.2 interface connection seat in accordance with another embodiment of the present invention.

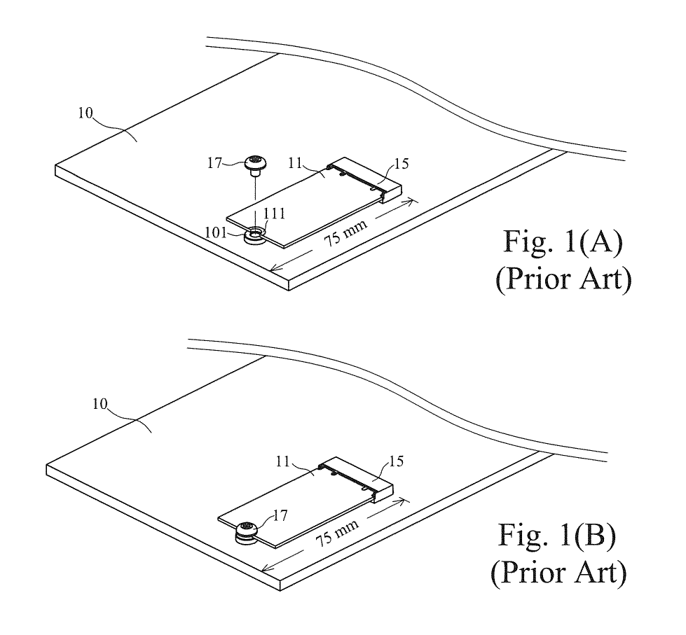

### DETAILED DESCRIPTION OF THE PREFERRED EMBODIMENTS

In order to further understand the present invention, preferred embodiments are to be described such that variations and alterations thereto are readily apparent to a person skilled in the art. However, it will be realized that the scope of this invention is not confined or restricted to the details of the embodiments described below. Identical reference numerals always designate the same elements throughout all the figures of the drawing.

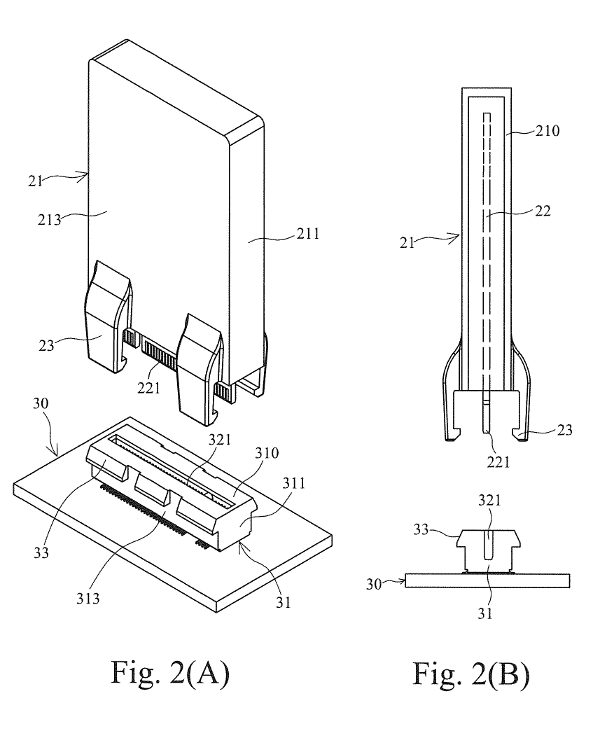

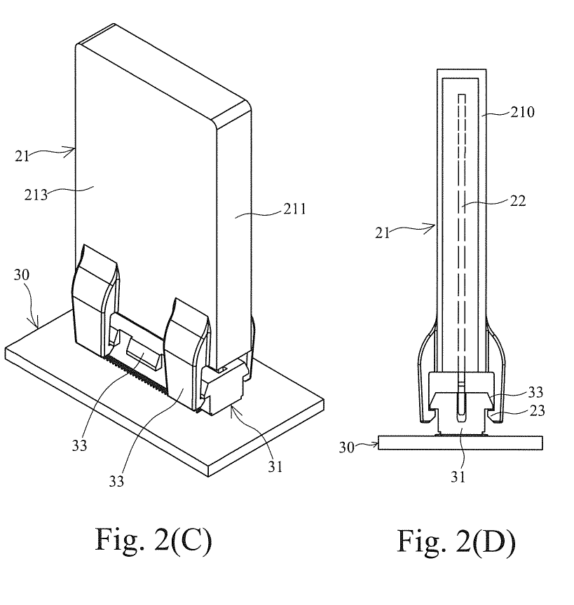

Referring to FIG. 2(A) and FIG. 2(B), there are shown a three-dimensional view and a cross-sectional view of the M.2 interface connector and the M.2 interface connection seat separated in accordance with an embodiment of the present invention, and the FIG. 2(C) and FIG. 2(D), there are shown a three-dimensional view and a cross-sectional view of the M.2 interface connector inserting into the M.2 interface connection seat in accordance with an embodiment of the present invention. The M.2 interface connector 21 and the M.2 interface connection seat 31 are the connector and the connection seat conforming to the M.2 interface standard specification. The M.2 interface connection seat 31 is disposed on a circuit board 30, and it's top end 310 is provided with a slot 321. The opening direction of the slot 321 will be perpendicular to the surface of the circuit board 30. The M.2 interface connector 21 includes a housing 210 and a M.2 interface card 22. The M.2 interface card 22 is a interface card conforming to the M.2 interface standard specification, and there is a connection interface 221 at the bottom of the M.2 interface card 22. The housing 210 is used for cladding the body of the M.2 interface card 22, and the connection interface 221 of the M.2 interface card is protruding from the bottom end of the housing 210.

When the M.2 interface connector 21 is inserting into the slot 321 of the M.2 interface connection seat 31 using the connection interface 221 of the M.2 interface card 22, the M.2 interface connector 21 will be inserted on the M.2 interface connection seat 31. Because the opening direction of the slot 321 is perpendicular to the surface of the circuit board 30. when the M.2 interface connector 21 is inserting into the M.2 interface connection seat 31, the M.2 interface connector 21 will be set vertically on the circuit board 30. The circuit board 30 doesn't need to preserve room for setting the M.2 interface connector 21 in this way. It will prevent affecting the setup of other interface components. Then every size and length of the M.2 interface card 22 of the M.2 interface connector 21 can set up on the circuit board 30.

Further, in the present invention, the side surfaces of the housing 210 of the M.2 interface connector 21 and/or the side surfaces of the M.2 interface connection seat 31 further provide with at least one fixed member. When the M.2 interface connector 21 is inserting into the M.2 interface connection seat 31, the M.2 interface connector 21 will be fixed on the M.2 interface connection seat 31 by the fixed member.

Take FIG. 2(A) to FIG. 2(D) for example, the housing 210 of the M.2 interface connector 21 includes two short side surfaces 211 and two long side surfaces 213, and the body of the M.2 interface connection seat 31 includes two short side surfaces 311 and two long side surfaces 313. The long side surfaces 213 of the housing 210 of the M.2 interface connector 21 provides with at least one flexed member, and the flexed member is a fastener 23. The long side surface 313 of the M.2 interface connection seat 31 provides with at least one protruding part 33. When the connection interface 221 of the M.2 interface card 22 is inserting into the slot 321 of the M.2 interface connection seat 31, the fastener 23 will be fixed on the protruding part 33.

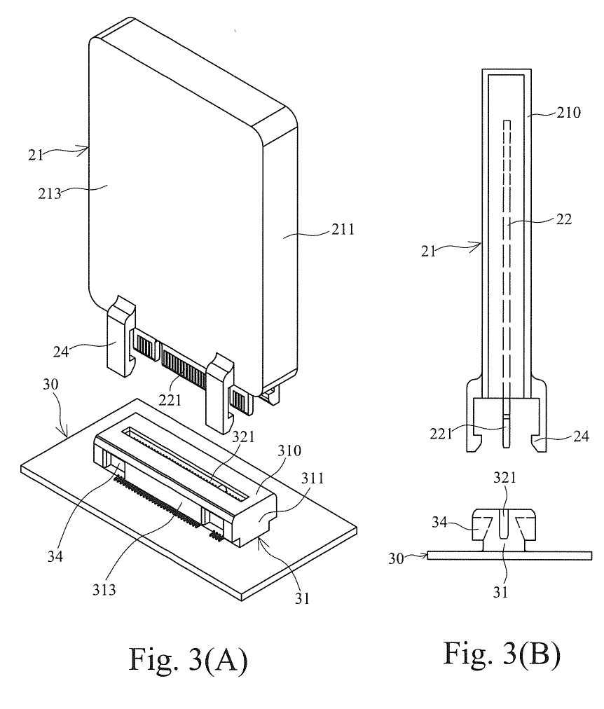

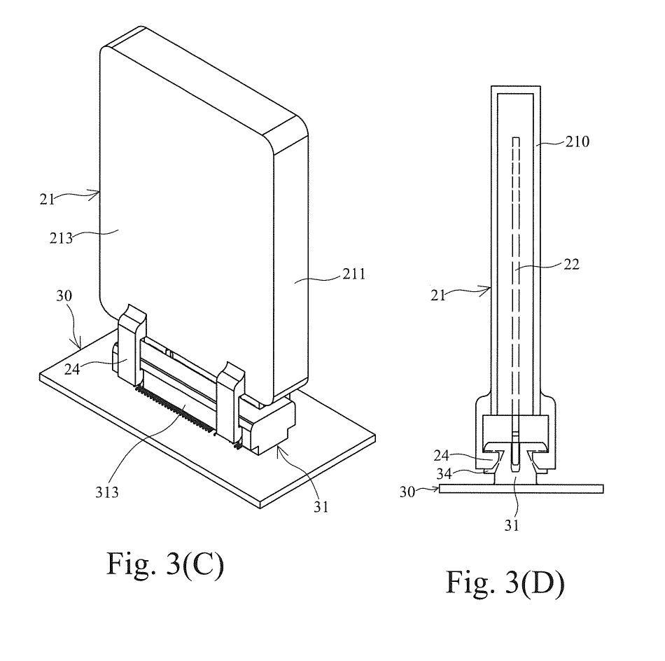

Take FIG. 3(A) to FIG. 3(D) for example, the long side surfaces 213 of the housing 210 of the M.2 interface connector 21 provides with at least one flexed member, and the flexed member is a fastener 24. The long side surface 313 of the M.2 interface connection seat 31 provides with at least one depression part 34. When the connection interface 221 of the M.2 interface card 22 is inserting into the slot 321 of the M.2 interface connection seat 31, the fastener 24 will be fixed on the depression part 34. And the M.2 interface connector 21 will be fixed on the body of the M.2 interface connection seat 31 by fixing the fastener 23/24 on the protruding part 33/depression part 34.

Further, the fastener 23/24 of the description in FIG. 2(A) to FIG. 2(D) or FIG. 3(A) to FIG. 3(D) can also setup on the short side surface 211 in addition to setup on the long side surface 213 of the housing 210. Similarly, the protruding part 33/depression part 34 can also setup on the short side surface 311 in addition to setup on the long side surface 313 of the M.2 interface connection seat 31.

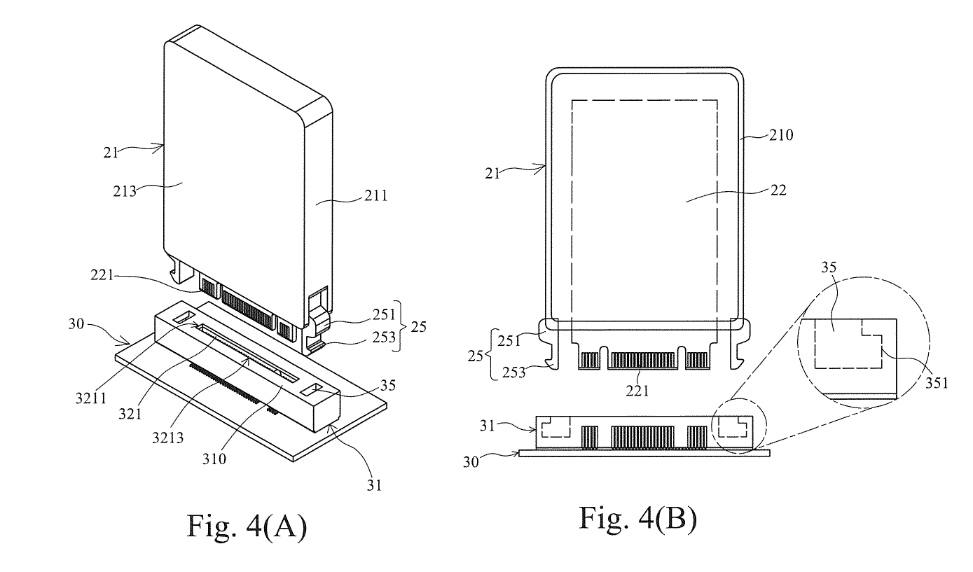

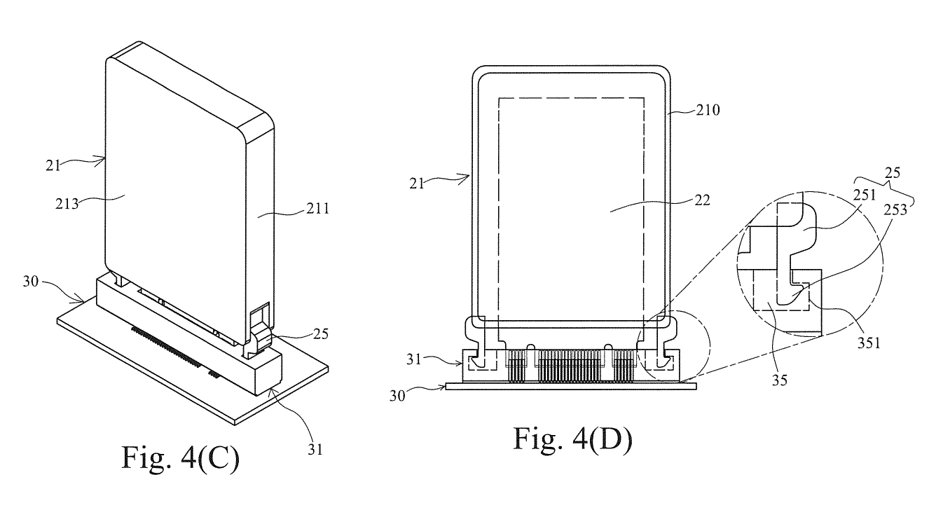

Referring to FIG. 4(A) and FIG. 4(B), there are shown a three-dimensional view and a cross-sectional view of the M.2 interface connector and the M.2 interface connection seat separated in accordance with another embodiment of the present invention, and the FIG. 4(C) and FIG. 4(D), there are shown a three-dimensional view and a cross-sectional view of the M.2 interface connector inserting into the M.2 interface connection seat in accordance with another embodiment of the present invention. In this embodiment, the two short side surfaces 211 of the housing 210 of the M.2 interface connector 21 provide with a fixed member respectively, the fixed member is a coupling member 25, the coupling member 25 includes a pressing portion 251, which extending downward provides with a hook 253.

Also, the slot 321 of M.2 interface connection seat 31 is formed by two short sides 3211 and two long sides 3213, the two sides of the short side 3211 of the slot 321 provide with a coupling slot 35 respectively, and the coupling slot 35 provides with a coupling hole 351 inside the coupling slot 35. When the connection interface 221 of the M.2 interface card 22 is inserting into the slot 321 of the M.2 interface connection seat 31, the hook 253 will move to the direction of the coupling hole 351 of the coupling slot 35 and be fixed in the coupling hole 351 of the coupling slot 35. And the M.2 interface connector 21 will be fixed on the body of the M.2 interface connection seat 31 by fixing the hook 253 of the coupling member 25 on the coupling hole 351 of the coupling slot 35.

Further, if the user wants to separate the M.2 interface connector 21 from the M.2 interface connection seat 31, the user can press the pressing portion 251 then the hook 253 will move in the opposite direction of the coupling hole 351 and separate from the coupling hole 351. Gripping part surface of the housing 210 of the M.2 interface connector 21 and lifting it at the same time will separate the M.2 interface connector 21 from the M.2 interface connection seat 31.

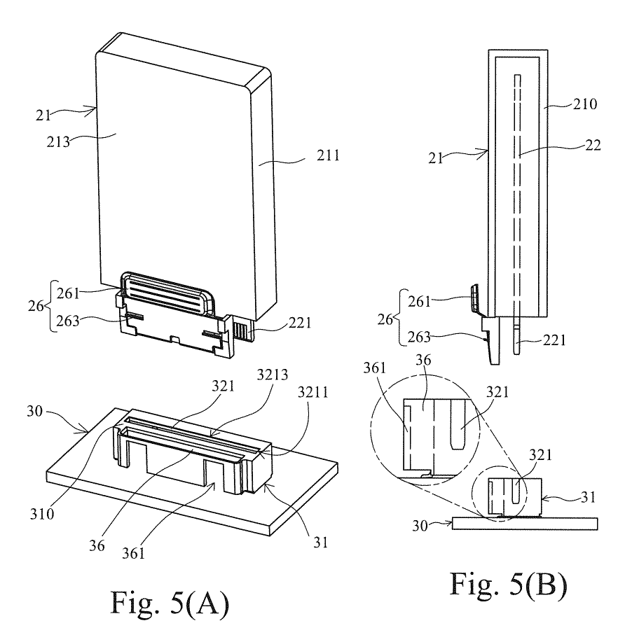

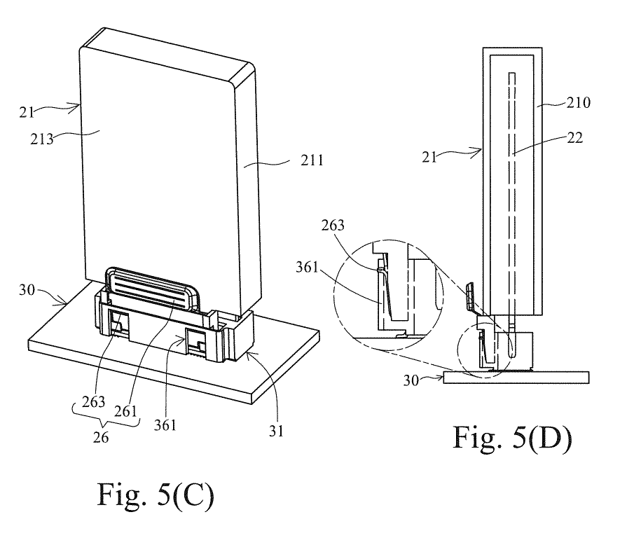

Referring to FIG. 5(A) and FIG. 5(B), there are shown a three-dimensional view and a cross-sectional view of the M.2 interface connector and the M.2 interface connection seat separated in accordance with another embodiment of the present invention, and the FIG. 5(C) and FIG. 5(D), there are shown a three-dimensional view and a cross-sectional view of the M.2 interface connector inserting into the M.2 interface connection seat in accordance with another embodiment of the present invention. In this embodiment, the two long side surfaces 213 of the housing 210 of the M.2 interface connector 21 provide with at least one fixed member, the fixed member is a coupling member 26, the coupling member 26 includes a pressing portion 261, which extending downward provides with a hook 263.

Also, the long side 3213 of the slot 321 of the M.2 interface connection seat 31 provides with at least one coupling slot 36, and the coupling slot 36 provides with a coupling hole 361 inside the coupling slot 36, where the coupling hole 361 can be a hollow opening. When the connection interface 221 of the M.2 interface card 22 is inserting into the slot 321 of the M.2 interface connection seat 31, the hook 263 will move to the direction of the coupling hole 361 of the coupling slot 36 and be fixed in the coupling hole 361 of the coupling slot 36. And the M.2 interface connector 21 will be fixed on the body of the M.2 interface connection seat 31 by fixing the hook 263 of the coupling member 26 on the coupling hole 361 of the coupling slot 36.

Further, if the user wants to separate the M.2 interface connector 21 from the M.2 interface connection seat 31, the user can press the pressing portion 261 then the hook 263 will move in the opposite direction of the coupling hole 361 and separate from the coupling hole 361. Gripping part surface of the housing 210 of the M.2 interface connector 21 and lifting it at the same time will separate the M.2 interface connector 21 from the M.2 interface connection seat 31.

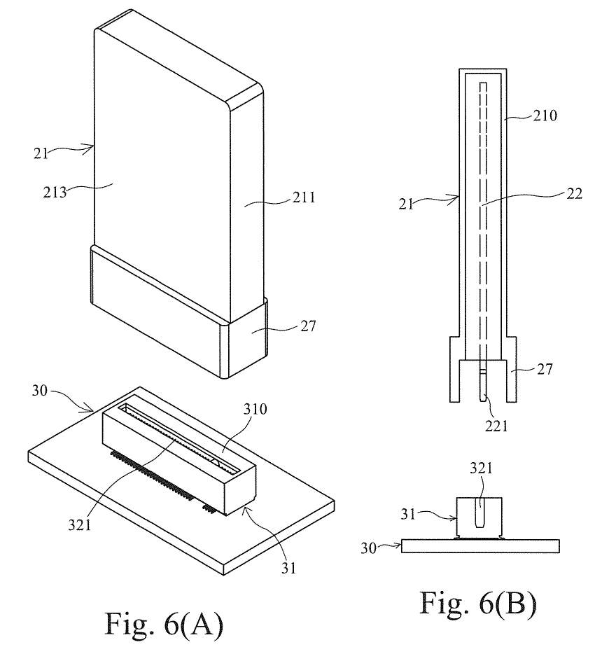

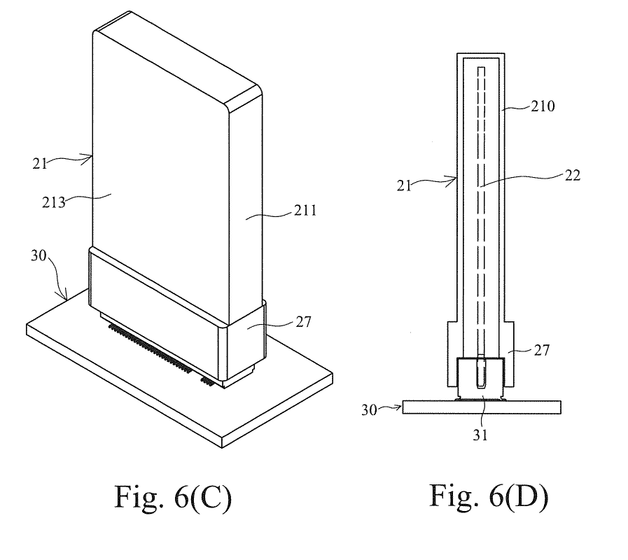

Referring to FIG. 6(A) and FIG. 6(B), there are shown a three-dimensional view and a cross-sectional view of the M.2 interface connector and the M.2 interface connection seat separated in accordance with another embodiment of the present invention, and the FIG. 6(C) and FIG. 6(D), there are shown a three-dimensional view and a cross-sectional view of the M.2 interface connector inserting into the M.2 interface connection seat in accordance with another embodiment of the present invention. In this embodiment, the bottom of the housing 210 of the M.2 interface connector 21 provides with a fixed member, the fixed member is a housing extension part 27.

When the connection interface 221 of the M.2 interface card 22 is inserting into the slot 321 of the M.2 interface connection seat 31, the housing extension part 27 will surround the outer surface of the body of the M.2 interface connection seat 31 and tightly touch the outer surface of the body of the M.2 interface connection seat 31. And the M.2 interface connector 21 will be fixed on the M.2 interface connection seat 31 by the coupling of the housing extension part 27 and the M.2 interface connection seat 31.

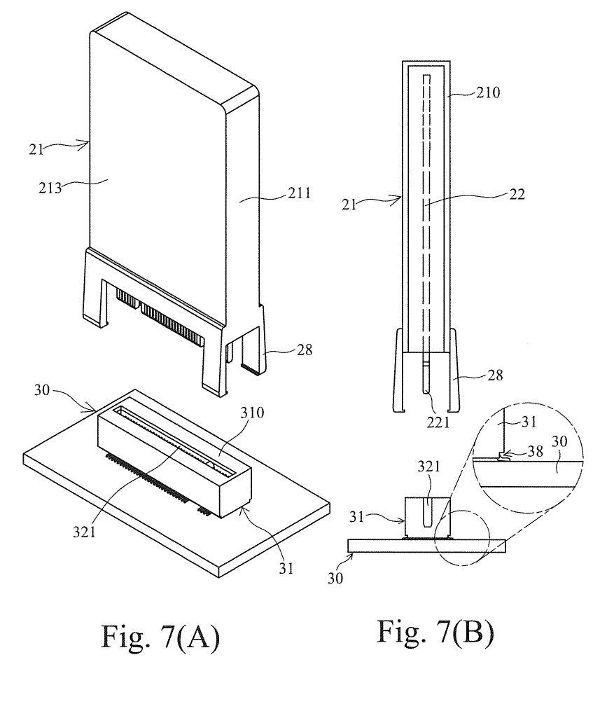

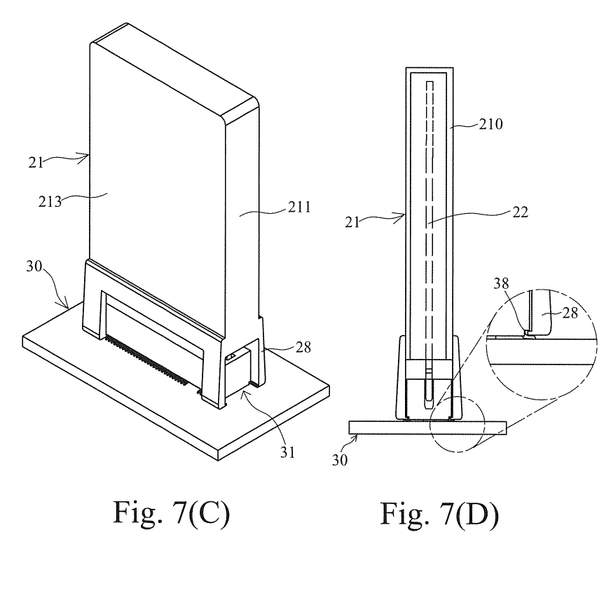

Referring to FIG. 7(A) and FIG. 7(B), there are shown a three-dimensional view and a cross-sectional view of the M.2 interface connector and the M.2 interface connection seat separated in accordance with another embodiment of the present invention, and the FIG. 7(C) and FIG. 7(D), there are shown a three-dimensional view and a cross-sectional view of the M.2 interface connector inserting into the M.2 interface connection seat in accordance with another embodiment of the present invention. In this embodiment, the two long side surfaces 213 of the housing 210 of the M.2 interface connector 21 provide with at least one fixed member, the fixed member is a fastener 28.

There is a fixed gap 38 between the M.2 interface connection seat 31 and the circuit board 30. When the connection interface 221 of the M.2 interface card 22 is inserting into the slot 321 of the M.2 interface connection seat 31, the fastener 28 of the housing 210 will be fixed in the fixed gap 38, and the M.2 interface connector 21 will be fixed on the M.2 interface connection seat 31.

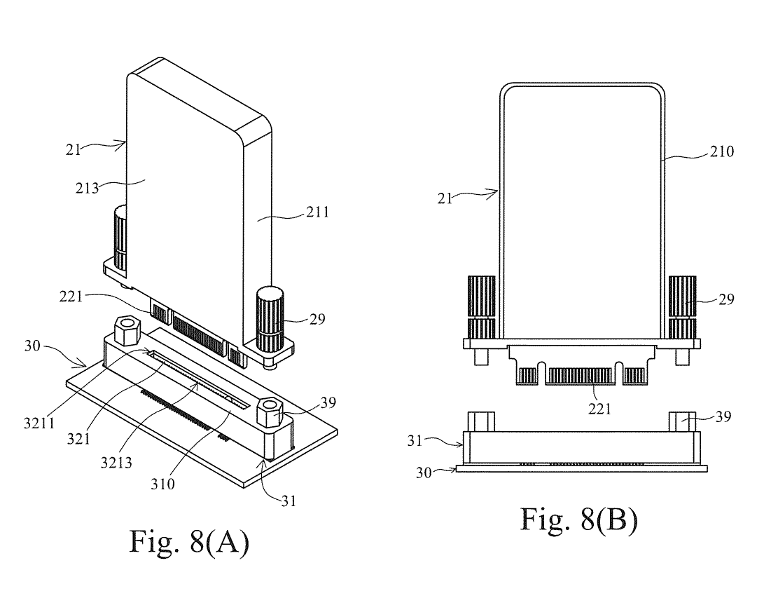

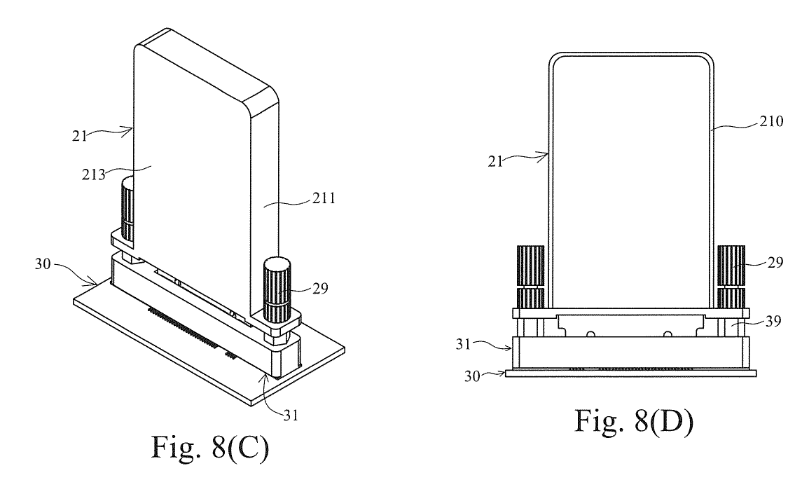

Referring to FIG. 8(A) and FIG. 8(B), there are shown a three-dimensional view and a cross-sectional view of the M.2 interface connector and the M.2 interface connection seat separated in accordance with another embodiment of the present invention, and the FIG. 8(C) and FIG. 8(D), there are shown a three-dimensional view and a cross-sectional view of the M.2 interface connector inserting into the M.2 interface connection seat in accordance with another embodiment of the present invention. In this embodiment, the two short side surfaces 211 of the housing 210 of the M.2 interface connector 21 extending provide with a fixed member respectively, and the fixed member is a screw fixed member 29.

Also, the two sides of the short side 3211 of the slot 321 of the M.2 interface connection seat 31 provide with a position cooper tube 39 respectively. When the connection interface 221 of the M.2 interface card 22 is inserting into the slot 321 of the M.2 interface connection seat 31, the screw fixed member 29 via the position cooper tube 39 and fixes on the position cooper tube 39. And the M.2 interface connector 21 will be fixed on the body of the M.2 interface connection seat 31 by the screw bolt between the screw fixed member 29 and the position cooper tube 39.

The present invention, as discussed herein, is industrially applicable, novel, and of significant value in technology development. It is to be understood; however, that this invention is not limited to the embodiments set forth and illustrated hereinabove, but encompasses any and all variations falling within the spirit and scope of this invention as defined by the appended claims and their equivalents.

What is claimed is:

1. A M.2 interface connection seat, which is a interface connection seat conforming to M.2 interface standard specification, is disposed on a circuit board, and a top end of the M.2 interface connection seat is provided with a slot, an opening direction of the slot is perpendicular to the surface of the circuit board, wherein the slot of the M.2 interface connection seat is provided for inserting a M.2 interface connector.

2. The M.2 interface connection seat as of claim 1, wherein the M.2 interface connection seat is provided on at least one side surface thereof with at least one protruding part, and the M.2 interface connector is provided on at least one side surface thereof with at least one fastener, when the M.2 interface connector is inserting into the slot of the M.2 interface connection seat, the fastener will be fixed on the protruding part.

3. The M.2 interface connection seat as of claim 1, wherein the M.2 interface connection seat is provided on at least one side surface thereof with at least one depression part, and the M.2 interface connector is provided on at least one side surface thereof with at least one fastener, when the M.2 interface connector is inserting into the slot of the M.2 interface connection seat, the fastener will be fixed on the depression part.

4. The M.2 interface connection seat as of claim 1, wherein the slot of M.2 interface connection seat is formed by two short sides and two long sides, the two sides of the short side of the slot provide with a coupling slot respectively, the M.2 interface connector includes two long side surfaces and two short side surfaces, the two short side surfaces of the M.2 interface connector provide with at least one coupling member respectively, the coupling member includes a pressing portion, which extending downward provides with a hook, when the M.2 interface connector is inserting into the slot of the M.2 interface connection seat, the hook will be fixed in a coupling hole of the coupling slot, when pressing the pressing portion of the coupling member, the hook will be separated from the coupling hole of the coupling slot.

5. The M.2 interface connection seat as of claim 1, wherein the slot of M.2 interface connection seat is formed by two short sides and two long sides, the long side of the slot provides with at least one coupling slot, the M.2 interface connector includes two long side surfaces and two short side surfaces, the long side surface of the M.2 interface connector provides with at least one coupling member, the coupling member includes a pressing portion, which extending downward provides with a hook, when the M.2 interface connector is inserting into the slot of the M.2 interface connection seat, the hook will be fixed in a coupling hole of the coupling slot, when pressing the pressing portion of the coupling member, the hook will be separated from the coupling hole of the coupling slot.

6. The M.2 interface connection seat as of claim 5, wherein the coupling hole of the coupling slot is a hollow opening.

7. The M.2 interface connection seat as of claim 1, wherein the bottom of the housing of the M.2 interface connector provides with a housing extension part, when the M.2 interface connector is inserting into the slot of the M.2 interface connection seat, the housing extension part will surround the outer surface of the body of the M.2 interface connection seat.

8. The M.2 interface connection seat as of claim 1, there is a fixed gap between the M.2 interface connection seat and the circuit board, and at least one side surface of the M.2 interface connector provides with a fastener, when the M.2 interface connector is inserting into the slot of the M.2 interface connection seat, the fastener will be fixed in the fixed gap.

9. The M.2 interface connection seat as of claim 1, wherein the slot of the M.2 interface connection seat is formed by two short sides and two long sides, the two sides of the short side of the slot provide with a position cooper tube respectively, the M.2 interface connector includes two long side surfaces and two short side surfaces, the two short side surfaces of the M.2 interface connector provide with a screw fixed member respectively, when the M.2 interface connector is inserting into the slot of the M.2 interface connection seat, using the screw bolt between the screw fixed member and the position cooper tube to fix the M.2 interface connector on the M.2 interface connection seat.

10. A M.2 interface connector, comprising:
a M.2 interface card, which is conforming to M.2 interface standard specification; and
a housing, setting in the outside of the M.2 interface card to wrap the body of the M.2 interface card, the connection interface of the M.2 interface card is protruding from the bottom end of the housing, at least one side surface of the housing provides with at least one fixed member;
when the connection interface of the M.2 interface card is inserting into a slot of the top end of a M.2 interface connection seat based on a vertical direction, the fixed member of the housing will be fixed on the body of the M.2 interface connection seat.

11. The M.2 interface connector as of claim 10, wherein the fixed member of the side surface of the housing is a fastener, the M.2 interface connection seat is provided on at least one side surface thereof with at least one protruding part, when the connection interface of the M.2 interface card is inserting into the slot of the M.2 interface connection seat, the fastener will be fixed on the protruding part.

12. The M.2 interface connector as of claim 10, wherein the fixed member of the side surface of the housing is a fastener, the M.2 interface connection seat is provided on at least one side surface thereof with at least one depression part, when the connection interface of the M.2 interface card is inserting into the slot of the M.2 interface connection seat, the fastener will be fixed on the depression part.

13. The M.2 interface connector as of claim 10, wherein the sides of the housing include two long side surfaces and two short side surfaces, the two short side surfaces of the housing provide with the fixed member respectively, the fixed member is a coupling member, the coupling member includes a pressing portion, which provides with a hook, the slot of the M.2 interface connection seat is formed by two short sides and two long sides, the two sides of the short side of the slot provide with a coupling slot respectively, when the connection interface of the M.2 interface card is inserting into the slot of the M.2 interface connection seat, the hook will be fixed in a coupling hole of the coupling slot, when pressing the pressing portion of the coupling member, the hook will be separated from the coupling hole of the coupling slot.

14. The M.2 interface connector as of claim 10, wherein the sides of the housing include two long side surfaces and two short side surfaces, the two long side surfaces of the housing provide with the fixed member respectively, the fixed member is a coupling member, the coupling member includes a pressing portion, which provides with a hook, the slot of M.2 interface connection seat is formed by two short sides and two long sides, the long side of the slot provides with at least one coupling slot, when the connection interface of the M.2 interface card is inserting into the slot of the M.2 interface connection seat, the hook will be fixed in a coupling hole of the coupling slot, when pressing the pressing portion of the coupling member, the hook will be separated from the coupling hole of the coupling slot.

15. The M.2 interface connector as of claim 14, wherein the coupling hole of the coupling slot is a hollow opening.

16. The M.2 interface connector as of claim 10, wherein the bottom of the housing of M.2 interface connector provides with the fixed member, the fixed member is a housing extension part, when the connection interface of the M.2 interface card is inserting into the slot of the M.2 interface connection seat, the housing extension part will surround the outer surface of the body of the M.2 interface connection seat.

17. The M.2 interface connector as of claim 10, there is a fixed gap between the M.2 interface connection seat and the circuit board, and the fixed member of the side surface of the housing is a fastener, when the connection interface of the M.2 interface card is inserting into the slot of the M.2 interface connection seat, the fastener will be fixed in the fixed gap.

18. The M.2 interface connector as of claim 10, wherein the sides of the housing include two long side surfaces and two short side surfaces, the two short side surfaces of the housing provides with the fixed member respectively, the fixed member is a screw fixed member, the slot of M.2 interface connection seat is formed by two short sides and two long sides, the two sides of the short side of the slot provide with a position cooper tube respectively, when the connection interface of the M.2 interface card is inserting into the slot of the M.2 interface connection seat, using the screw bolt between the screw fixed member and the position cooper tube to fix the M.2 interface connector on the M.2 interface connection seat.
